(19) United States
(12) Patent Application Publication
(10) Pub. No.: US 2026/0284503 A1
(43) Pub. Date: Sep. 24, 2026

(54) GOLF CART WITH CUSTOMIZABLE DISPLAY SCREEN

(71) Applicant: BC Companies, LLC, Loxley, AL (US)

(72) Inventor: Robert Brad Conquest, Loxley, AL (US)

(73) Assignee: BC Companies, LLC, Loxley, AL (US)

(21) Appl. No.: 19/571,094

(22) Filed: Mar. 18, 2026

Related U.S. Application Data
(60) Provisional application No. 63/775,752, filed on Mar. 21, 2025.

(51) Int. Cl. A63B 71/06; B60Q 1/50; B60Q 3/66; B60Q 3/70; G06F 3/14; G06F 3/16; A63B 55/60; A63B 57/00

(52) U.S. Cl. CPC A63B 71/0622; B60Q 1/503; B60Q 3/66; B60Q 3/70; G06F 3/1423; G06F 3/165; A63B 55/61; A63B 57/505; A63B 2071/0691; A63B 2220/12; B60Q 2800/00

(57) ABSTRACT

A golf cart with a customizable display system comprises a body structure configured to accommodate passengers, a roof assembly supported above the body structure, and a roof display integrated into the roof assembly. The roof display comprises a plurality of light emitters arranged in a pattern and configured to emit light downward toward occupants of the golf cart. The golf cart further comprises a front cowl forming a front section of the golf cart and a front display positioned on the front cowl and configured to present visual information to external observers. A control module is operatively connected to the roof display and the front display, the control module configured to control visual output of the roof display and the front display.

### CROSS REFERENCE TO RELATED APPLICATIONS

This application claims the benefit of U.S. Provisional Application No. 63/775,752, filed on March 21, 2025, which is herein incorporated entirely by reference.

### FIELD OF INVENTION

The present disclosure relates to golf carts, and more particularly to a golf cart with roof display and a front display capable of displaying customizable lighting patterns and information.

### BACKGROUND

Golf carts have long been a staple in the golfing industry, providing convenient transportation for players across courses. Over time, their utility has expanded beyond golf, finding applications in various settings such as resorts, retirement communities, events, workplaces, and even urban environments. As the use of golf carts has diversified, there has been a growing demand for enhanced features and customization options to cater to different user preferences and environments. Traditional golf cart designs have prioritized basic functionality over aesthetic appeal or user experience enhancements. The standard golf cart typically offers minimal visual customization options, limiting owners to basic paint colors or simple decals. This lack of personalization options has become increasingly problematic as golf carts are used in more diverse and visible settings where appearance and branding matter.

Current golf cart display solutions, where they exist, are typically limited to basic dashboard gauges or small aftermarket screens that provide minimal functionality. These existing displays often lack integration with the overall vehicle design, appearing as obvious add-ons rather than cohesive components. The placement of such displays is generally restricted to the dashboard area, limiting visibility and usefulness for passengers or external observers. Aftermarket lighting solutions for golf carts tend to focus solely on functional illumination rather than aesthetic or informational purposes. These solutions frequently require complex installation procedures and may not be compatible with all golf cart models. The lack of standardized display systems in the golf cart industry has resulted in fragmented and inconsistent user experiences across different vehicles and applications.

Golfers currently rely on separate devices such as smartphones, handheld GPS units, or course-provided tablets to access course information, weather data, and scoring tools. This reliance on multiple disconnected devices creates inconvenience and distraction during play. Existing solutions require golfers to look away from their surroundings and manually interact with handheld devices, potentially slowing pace of play. The information provided by these separate devices is not integrated with the golf cart itself, missing opportunities for location-aware or context-sensitive displays. Weather information, course maps, and scoring applications each typically require separate applications or devices, fragmenting the user experience. The absence of integrated display systems in golf carts means that valuable real estate on the vehicle remains unutilized for informational or entertainment purposes.

In non-golfing applications, golf carts used at resorts, events, or communities face similar limitations in communicating information to passengers or bystanders. Current golf carts lack effective means to display route information, identification, or branding to external observers. Event organizers and resort operators have limited options for customizing golf cart appearances to match themes or convey directional information. The automotive industry has embraced advanced lighting and display technologies, but these innovations have not been effectively adapted for the golf cart market. Existing attempts to add display capabilities to golf carts often result in systems that are difficult to control, lack weather resistance, or fail to integrate with other vehicle systems. These shortcomings have left a significant gap in the market for golf carts that can provide customizable visual experiences for both occupants and external observers.

Accordingly, there is a need in the art for a golf cart with integrated, customizable display systems that enhance both aesthetic appeal and user experience.

### SUMMARY

A golf cart with a customizable display system is provided. In one aspect, the present invention is a golf cart incorporating integrated display systems for enhanced visual customization and information presentation. In another aspect, the present invention is a roof display comprising a plurality of light emitters configured to display customizable lighting patterns. In yet another aspect, the present invention is a front display positioned on a front cowl of the golf cart for presenting visual information to external observers. In still another aspect, the present invention is a method for enhancing a golf cart experience through coordinated display outputs. Generally, the present invention is aimed towards providing golf carts with integrated, customizable display systems that enhance both aesthetic appeal and user experience.

The system preferably comprises a roof display integrated into a roof assembly of the golf cart, wherein the roof display includes a plurality of light emitters arranged in a pattern across its surface. The light emitters may comprise LEDs, fiber optic strands, or pixels of a display screen such as an LCD, OLED, or other display type. A cover panel may be positioned over the light emitters, featuring clear, translucent, smoked, or mirrored finishes with optional optical elements such as diffraction gratings or frosted surfaces. A front display may be integrated into a front cowl of the golf cart, providing visibility to external observers and capable of displaying decorative patterns, branding, or informational content.

The system preferably includes a control module operatively connected to the roof display and the front display, configured to adjust parameters of the lighting patterns and control visual output. The control module may connect to various sensors including GPS sensors, compasses, barometers, anemometers, accelerometers, gyroscopes, microphones, and cameras. A user interface, accessible via a built-in control panel or mobile application, allows users to customize brightness, colors, and dynamic effects. The system may display various content including weather information, interactive course maps, digital scorecards, virtual caddie suggestions, health metrics, personal media, and decorative patterns such as star fields or celestial displays.

A method for enhancing a golf cart experience is also provided. The method includes displaying customizable lighting patterns on a roof display integrated into a roof assembly of a golf cart, presenting visual information on a front display integrated into a front cowl of the golf cart, and controlling, via a control module, the customizable lighting patterns and visual information. The method may further include synchronizing the displays, adjusting patterns based on user input, responding to external stimuli such as music or motion, and presenting golf-related information including course maps, weather conditions, and player statistics.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

These and other features, aspects, and advantages of the present invention will become better understood with regard to the following description, appended claims, and accompanying drawings where:

FIG. 1A illustrates a perspective view of a golf cart with a customizable display system, according to an embodiment of the present disclosure.

FIG. 1B illustrates perspective views of components for a golf cart including a roof assembly and a front cowl assembly, according to an embodiment of the present disclosure.

FIG. 2 illustrates a block diagram of a display system for a golf cart showing the control module and its connections to various sensor and input components, according to an embodiment of the present disclosure.

FIG. 3 illustrates a perspective view of a golf cart in an outdoor environment, according to an embodiment of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

The present disclosure relates to a golf cart with enhanced visual features and customizable display capabilities. In a preferred embodiment, the golf cart may include a roof display integrated into a roof assembly and a front display positioned on a front cowl of the vehicle. The roof display may be configured to include a plurality of light emitters arranged in a pattern across its surface, enabling the presentation of customizable lighting patterns visible to occupants seated within the golf cart. In some preferred embodiments, the front display may provide a visible surface for presenting decorative patterns, branding information, or other visual content to external observers. A control module may be operatively connected to both displays, allowing for coordinated visual outputs and user-adjustable parameters such as brightness, colors, and dynamic effects. The system can enhance the aesthetic appeal and functionality of the golf cart across various applications including golf courses, resorts, residential communities, and event venues.

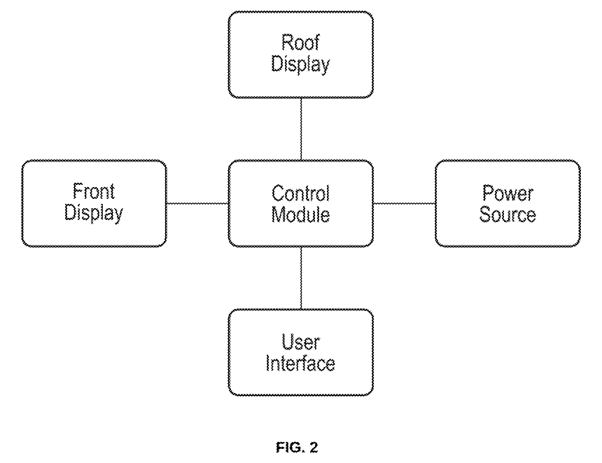

In another preferred embodiment, the display system may incorporate various sensor components to enable context-aware functionality. As illustrated in FIG. 2, the control module may connect to sensors such as GPS sensors, compasses, barometers, anemometers, accelerometers, gyroscopes, microphones, and cameras. In some instances, these sensors can provide data that allows the displays to respond to environmental conditions, user activities, or external stimuli such as music or vehicle motion. For example, GPS data may enable location-based features such as interactive course maps, while compass data can orient directional information relative to the golf cart's heading. Alternatively, the system may utilize camera input to create a virtual sunroof effect by displaying real-time imagery of the sky above the vehicle. The integration of multiple sensor types may allow for sophisticated display functionalities that adapt to the user's context and preferences.

In some preferred embodiments, the displays may be configured to present a variety of content types depending on the intended use of the golf cart. The roof display can optionally show weather information, interactive course maps, digital scorecards, virtual caddie suggestions, health metrics from connected wearable devices, or personal media such as photos and videos. In some instances, the display may present decorative patterns such as simulated star fields or celestial events for ambiance during evening use. The front display may be configured to show identification information, route designations, charge status, or event-specific branding depending on the operational context. For example, at a resort the front display may indicate shuttle destinations, while during a tournament it may display player names or team affiliations. This versatility can expand the utility of the golf cart beyond traditional golfing applications to encompass transportation, entertainment, and promotional uses.

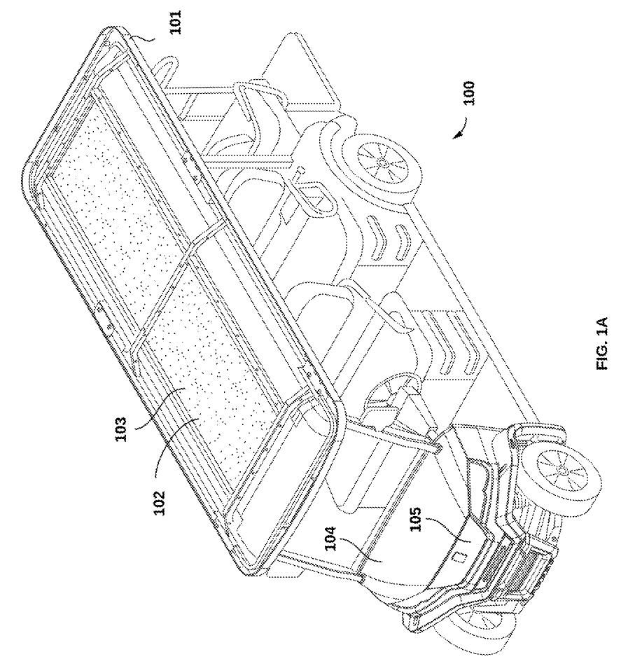

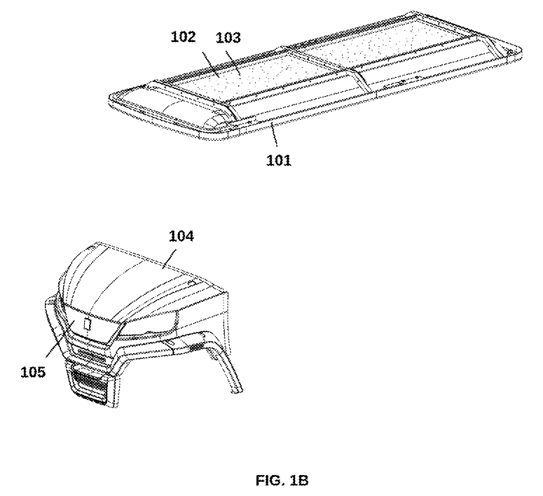

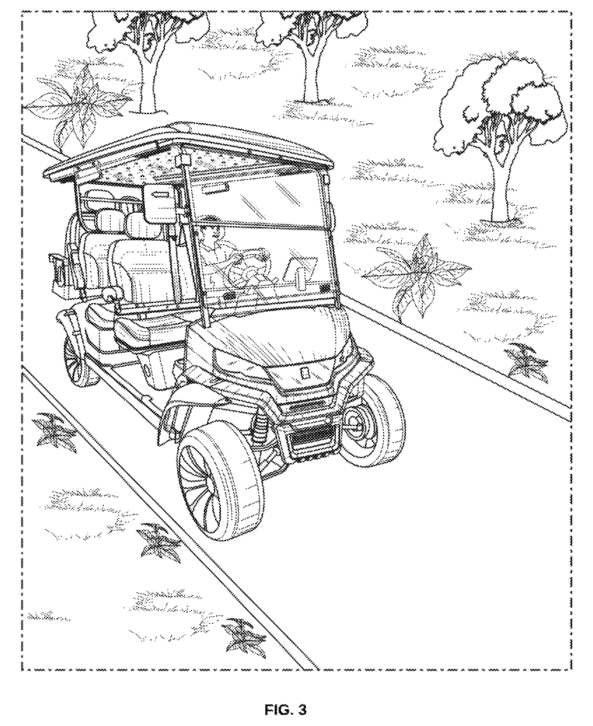

FIGS. 1A-3 illustrate embodiments of a system and method for a golf cart with customizable display system. FIG. 1A illustrates a perspective view of a golf cart 100 with a customizable display system, showing the roof assembly 101, roof display 102, light emitters 103, front cowl 104, and front display 105. FIG. 1B illustrates perspective views of components for a golf cart 100 including a roof assembly 101 and a front cowl 104 assembly, with the roof assembly 101 shown with the top cover removed to allow a better view of how the components are arranged, including the roof display 102 with light emitters 103 and the front display 105 positioned on the front cowl 104. FIG. 2 illustrates a block diagram of a display system for a golf cart showing the control module and its connections to various sensor and input components including a GPS sensor, compass, barometer, anemometer, accelerometer, gyroscope, microphone, and camera. FIG. 3 illustrates a perspective view of a golf cart in an outdoor environment, depicting the vehicle on a paved path surrounded by landscaping elements and showing the roof assembly with integrated roof display and the front cowl with front display. It is understood that the methods disclosed herein may be carried out by the system illustrated in FIGS. 1A-3.

As illustrated in FIGS. 1A and 1B, the present disclosure describes a golf cart 100 that may comprise a roof assembly 101 and a front cowl 104, which can incorporate displays and provide overhead protection for occupants. In a preferred embodiment, the roof assembly 101 may be supported by tubular metal supports attached to the main body of the golf cart 100, providing structural stability while maintaining an open feel for passengers. The roof assembly 101 can be designed to integrate seamlessly with the overall aesthetic of the golf cart 100 while incorporating functional elements such as the roof display 102. In some preferred embodiments, the roof assembly 101 may extend over the seating area to provide coverage for both front and rear passengers. The front cowl 104 may form the forward-facing structure of the golf cart 100 and can house various components including lighting elements and the front display 105. As illustrated in FIG. 1B, the roof assembly 101 is shown with the top cover removed to allow a better view of how the components are arranged, revealing the positioning of the roof display 102 and light emitters 103.

As illustrated in FIG. 1A, the golf cart 100 may include a body structure designed to accommodate passengers and equipment while providing mobility on various terrains. In some preferred embodiments, the golf cart 100 may be configured for use on golf courses, where players can benefit from the integrated display capabilities during their rounds. In another preferred embodiment, the golf cart 100 may be adapted for transportation in residential communities, resorts, or recreational areas where visual customization and information display can enhance the user experience. The golf cart 100 can feature seating for multiple passengers, with forward-facing seats visible in the front section and optionally rear-facing seats in the back section. In some instances, the vehicle may include wheels with styled hubcaps, a front bumper assembly, and side step areas for passenger entry and exit. The overall design of the golf cart 100 can integrate the roof display 102 and front display 105 into the vehicle structure while maintaining the functional characteristics for transportation purposes.

As illustrated in FIGS. 1A and 1B, the roof display 102 may be integrated into the roof assembly 101, spanning a substantial portion of the roof's length to provide ample display area for occupants. The roof display 102 can be positioned to be visible to occupants of the golf cart 100 when looking upward, creating an immersive visual experience. In a preferred embodiment, the roof display 102 may be surrounded by a decorative polymer frame, enhancing its visual appeal and integration with the roof structure. The roof display 102 may be shown as a long rectangular section inside of the decorative polymer surround, as depicted in FIG. 1B. In some preferred embodiments, the roof display 102 comprises a plurality of light emitters 103 arranged in a pattern across its surface, enabling the presentation of customizable lighting patterns. The light emitters 103 may be configured to emit light downward toward the driver and passengers of the golf cart 100, providing visual content that can be viewed from the seating positions below.

In some preferred embodiments, the light emitters 103 may be individual light bulbs such as LEDs or incandescent bulbs arranged in various configurations across the roof display 102. Alternatively, the light emitters 103 may be the ends of fiber optic strands arranged in customizable patterns, which can be fed by one or more light sources such as LEDs or incandescent bulbs positioned remotely. In another preferred embodiment, the light emitters 103 may be part of a screen such as a Light Emitting Diode (LED) display, Organic Light Emitting Diode (OLED) display, Liquid Crystal Display (LCD), Plasma display, Electroluminescent (EL) display, Electronic paper (E-ink) display, Quantum dot display, MicroLED display, Mini-LED display, Laser projection display, Digital Light Processing (DLP) display, Vacuum fluorescent display (VFD), Field emission display (FED), Surface-conduction electron-emitter display (SED), Interferometric modulator display (IMOD), Electrochromic display, or other type of display technology. When a screen is used, each pixel or portion thereof may be considered a light emitter for the purposes of the present disclosure. In some instances, the selection of light emitter type can depend on factors such as desired brightness, color range, power consumption, and environmental durability. The flexibility in light emitter selection allows the roof display 102 to be configured to meet various performance and aesthetic specifications.

In a preferred embodiment, the roof display 102 may be covered by a panel that affects the appearance of the emitted light, providing both protection and optical enhancement. In some preferred embodiments, this cover panel may have a clear, translucent, smoked, or mirrored finish, which can be matte or glossy depending on the desired visual effect. The cover panel of the roof display 102 may incorporate various optical elements to enhance or modify the light output from the light emitters 103. A rough or frosted surface can be used to diffuse the light, creating a softer, more uniform glow across the display that may help reduce glare and create a more pleasant viewing experience for the golf cart occupants. In another preferred embodiment, diffraction gratings can be integrated into the cover panel to create intricate patterns or effects when light passes through them, as these gratings consist of closely spaced grooves or slits that cause light to spread out into its component wavelengths. This can result in rainbow-like effects or specific patterns of light distribution across the roof display 102, adding visual interest and complexity to the lighting patterns.

In some preferred embodiments, a plurality of optical elements can be used in combination to create a wide range of visual effects on the roof display 102. For example, a section of the cover panel might use diffraction gratings to create star-like patterns, while another section uses a frosted surface to provide ambient illumination. Alternatively, prisms may be incorporated into the cover panel to split light into component colors, creating spectral displays that can enhance decorative lighting modes. The present disclosure contemplates that various combinations of optical treatments may be applied to different regions of the cover panel to achieve zone-specific visual effects. In some instances, the cover panel may be configured to be removable or interchangeable, allowing users to customize the optical characteristics of the roof display 102 based on their preferences. The integration of optical elements into the cover panel can enhance the versatility of the roof display 102 while protecting the underlying light emitters 103 from environmental exposure.

In a preferred embodiment, the system may include a control module, allowing for control of the various lights of the system and enabling users to adjust brightness, colors, and dynamic effects of the roof display 102 to provide a wide range of visual effects and functionalities both on and off the golf course. In some preferred embodiments, a computing device having a user interface may act as the control module, wherein said user interface may be configured to allow users to adjust various parameters of the display. The control module can be part of a built-in control panel of the golf cart 100, providing direct access to display settings without external devices. Alternatively, a computing device of a user may be used to operably connect to the system and allow control thereof, such as a mobile app on a user's smartphone or tablet that can connect to the system via wireless protocols. In some instances, the user interface may provide preset display modes that users can select, as well as advanced customization options for creating personalized lighting patterns. The control module may be configured to store user preferences and display configurations, allowing for quick recall of favorite settings across multiple uses of the golf cart 100.

In some preferred embodiments, the roof display 102 may be configured to display real-time weather conditions to assist golfers and other users in planning their activities. The control module may receive weather data from external sources via network connection or from onboard sensors and present this information on the roof display 102. For example, the roof display 102 may show current temperature, wind speed and direction, humidity levels, and precipitation forecasts, allowing golfers to prepare for changing conditions on the course. The current temperature may be determined by retrieving weather data from the internet based on the GPS location of the golf cart 100, while wind speed and direction may be based on readings from an anemometer mounted on the golf cart 100. Alternatively, the wind speed and direction may be received via network connection, and an onboard compass may be used to display a pointer on the screen showing the wind direction relative to the golf cart 100's current heading. In some instances, the weather display may include graphical representations such as animated wind arrows or color-coded temperature indicators to enhance readability while the golf cart 100 is in motion.

In some preferred embodiments, the roof display 102 may show an interactive map of the golf course, offering real-time, location-based information to users of the system. The interactive map may include various layers of information to provide comprehensive course details that can assist players throughout their round. For instance, the map may display the overall layout of the course, including hole numbers, par information, and yardage markers for various points of interest. Tee boxes, fairways, and greens may be clearly delineated, potentially using different colors or patterns to distinguish these areas from one another. The map can also indicate the locations of course facilities such as restrooms, refreshment stands, beverage carts, or the clubhouse. In another preferred embodiment, the interactive map may be configured to display elevation changes along the course, helping players understand uphill and downhill shots they may encounter.

In some preferred embodiments, the interactive map may present hazards to the user, including, but not limited to, trees, water features, sand traps, out of bounds areas, or any combination thereof. For instance, trees may be represented by small icons or shaded areas indicating their approximate locations and coverage, while water hazards could be shown in blue to clearly distinguish them from other course features. Sand traps or bunkers might be indicated by yellow or beige areas that correspond to their actual shapes and positions on the course. Out of bounds areas might be represented by red transparent shading or boundary lines to alert players to areas where penalty strokes would apply. In some instances, the map may also display cart path locations, helping drivers navigate the course while adhering to course rules regarding cart access. The hazard display can be configured to show distances from the current position to various hazards, assisting players in club selection and shot planning.

In another preferred embodiment, the map may be dynamically updated based on the golf cart 100's current location, providing users with a clear overview of the course layout and their progress through the round. As the golf cart 100 moves across the course, the map on the roof display 102 may continuously update, showing the cart's current position relative to course features in real time. This dynamic updating may be achieved through GPS, compass, or other positioning technologies to track the golf cart 100's location and orientation on the course, allowing for precise location tracking. The interactive map may also be configured to display dynamic elements other than a user's location on the map, such as the positions of other golf carts on the course, helping to manage pace of play and avoid congestion. For example, the roof display 102 may provide real-time updates on a player's location and direction and yardage to the hole, helping players make informed decisions about club selection and shot strategy. In some instances, the map can automatically zoom in or out based on the current hole being played, providing appropriate detail levels for different situations.

In some preferred embodiments, the interactive map may be programmed to offer additional map-related features that enhance the golfing experience. For instance, it could provide suggested routes between holes, helping players navigate the course efficiently while avoiding restricted areas or congested paths. The map might also offer flyover views of each hole, giving players a bird's-eye perspective to aid in shot planning and course strategy. To further enhance its utility, the interactive map could incorporate touch-screen functionality, allowing players to interact directly with the roof display 102 when the golf cart 100 is stationary. Players may be able to zoom in on specific areas of the course, measure distances between points, or access additional information about particular features by tapping on them. In some instances, the map can display historical data such as previous shot locations or scoring trends for specific holes, helping players learn from past rounds.

In some preferred embodiments, the system may comprise a virtual caddie feature, which may provide tips and suggestions to improve the player's performance during their round. The control module may analyze factors such as player position, course layout, wind conditions, and weather data to provide recommendations for club selection or shot strategy. These suggestions may be displayed on the roof display 102, potentially improving player performance and enhancing the golfing experience for players of various skill levels. The control module's analysis can take into account a comprehensive set of factors to generate its recommendations, such as positional data from GPS sensors, course data from stored databases, and hazard data indicating obstacles between the player and the target. In addition, the virtual caddie feature could potentially incorporate player-specific data to further refine its recommendations, including the player's average distances with different clubs, their typical shot dispersion patterns, and their playing style preferences. Such personalization could be achieved by accessing player profile data in a database or may learn from the player's performance over time through machine learning algorithms.

In a preferred embodiment, based on the analysis, the system may generate a suggested club, hit direction, and ball placement to assist the player in executing their shot. The suggested club may be displayed along with a map showing the direction to hit the ball and suggested shot placement relative to hazards and the target. For club selection, the system might suggest not just the type of club but also provide reasoning behind the choice, such as accounting for headwind, elevation changes, or the need to clear a specific hazard. Shot strategy recommendations could include target areas for optimal positioning, suggestions for shot shape such as draw or fade, and advice on whether to play aggressively or conservatively based on the player's current score and position in the round. The virtual caddie feature could be particularly beneficial for players who are unfamiliar with a specific course or for those who are developing their golf skills. In some instances, the system may provide alternative shot options, allowing players to choose between different strategies based on their comfort level and risk tolerance.

In some preferred embodiments, the roof display 102 may integrate a digital scorecard that allows players to track their scores throughout the round without paper or separate devices. The digital scorecard functionality may be designed to be intuitive and user-friendly, minimizing the time and effort needed to record scores. Players could input their scores after each hole using the user interface, which might include touch-screen capabilities on the roof display 102 itself or through a connected mobile device. The control module could process this input and update the scorecard in real-time, ensuring that the most current information is displayed for review. The presentation of the scorecard on the roof display 102 could be customized to maximize readability and usefulness, showing the current hole's score, running totals, and comparative data such as the player's performance relative to their handicap or previous rounds. In some instances, the display could use contrasting colors or larger fonts to highlight information such as birdies or bogeys, ensuring visibility even in bright sunlight conditions often encountered on golf courses.

In another preferred embodiment, the digital scorecard format opens up possibilities for advanced features such as automatic calculation of handicaps, statistical analysis of a player's performance over time, or integration with golf course management systems for official tournament scoring. The ease of score tracking facilitated by this feature could enhance the pace of play, as players would no longer need to stop and manually record scores on paper cards. This could lead to a smoother, more enjoyable golfing experience, particularly in competitive or time-sensitive situations where delays can affect other groups on the course. Furthermore, the digital scorecard could potentially integrate with other features of the display system, such as working in conjunction with the GPS and mapping features to automatically detect when a hole is completed and prompt for score entry. In some instances, the scorecard may be configured to track additional statistics such as fairways hit, greens in regulation, and putts per hole for players interested in detailed performance analysis. The digital scorecard data may optionally be exported or shared via network connection for record-keeping or social sharing purposes.

In some preferred embodiments, the roof display 102 may integrate with social media accounts to enable sharing and communication features during use of the golf cart 100. Users may be able to connect their social media profiles through the user interface, allowing them to view notifications or post updates directly from the golf cart 100 without accessing separate devices. Players may share their scores, achievements, or memorable moments directly from the golf cart 100, enhancing social engagement during golfing events or recreational outings. The user interface, which may be accessible through a built-in control panel or a computing device of a user, can allow users to log into their preferred social media platforms securely. Once connected, the roof display 102 could show a variety of social media-related content, such as recent notifications including new messages, comments, or other platform-specific alerts. In some instances, the social media integration may be configured to filter notifications based on user preferences, showing relevant updates while minimizing distractions during play.

In another preferred embodiment, the ability to post updates directly from the golf cart 100 opens up possibilities for real-time sharing of the golfing experience with friends, family, or followers. Users could potentially share their current location on the course, post photos or videos of scenic views, or update their scores as they progress through their round. This real-time sharing capability could be particularly appealing during charity tournaments or corporate events, allowing participants to engage with a broader audience and potentially increase the event's visibility and impact. The social media integration could also facilitate communication between players on the course, such as groups in different carts sharing their locations or coordinating meet-up points at the turn. In some instances, this feature might also be useful for course management, allowing staff to send notifications or updates to connected carts simultaneously regarding weather alerts or course conditions. The present disclosure contemplates that social media features may be disabled or restricted based on user preferences or course policies to maintain focus during competitive play.

In some preferred embodiments, the system may be configured to display health and fitness tracking information on the roof display 102 for users interested in monitoring their physical activity. The control module may receive data from wearable devices or smartphone apps and present this information on the roof display 102 in an easily readable format. This connectivity allows for seamless integration of personal health technology with the golf cart 100's display system, providing consolidated health data without requiring users to check multiple devices. The control module may utilize wireless communication protocols such as Bluetooth or Wi-Fi to establish connections with these external devices, ensuring real-time data transfer and display. Users may be able to view metrics such as steps taken, calories burned, heart rate, or distance walked during their golfing session. In some instances, these metrics can be displayed in various formats, such as numerical readouts, graphical representations, or progress bars, depending on user preferences and the nature of the data being presented.

In a preferred embodiment, the display of health metrics may provide golfers with immediate feedback on their physical activity during the game, helping them understand their exertion levels throughout the round. This real-time information can help players gauge their exertion levels and make informed decisions about their pace and intensity of play, such as choosing to walk more between holes or take rest breaks when needed. For example, a player noticing an elevated heart rate might choose to take a brief rest between holes or increase their hydration. Additionally, the visibility of health metrics can potentially encourage physical activity and wellness awareness by making this information readily available during recreational activities. Players might be motivated to walk more between holes or engage in more vigorous activity to increase their step count or calorie burn during the round. In some instances, the health tracking feature may also be integrated with other functionalities of the roof display 102, such as combining with the course mapping feature to provide estimates of calories burned based on the terrain covered or working with the weather display to offer suggestions for hydration based on temperature and physical exertion.

In some preferred embodiments, the roof display 102 may also be capable of displaying personal photos or videos uploaded by users for entertainment or personalization purposes. Users can interact with the system through the control module, which may be a touchscreen panel integrated into the golf cart 100's dashboard or a connected mobile device. The user interface of the control module may allow for easy uploading, selection, and management of personal media content from various sources. This feature of allowing for the display of personal photos or videos offers various applications both on and off the golf course, enhancing the versatility of the golf cart 100. For instance, during a round of golf, players might showcase photos from previous golfing achievements, display images of the course's signature holes, or present sponsorship logos during corporate events or tournaments. In some instances, this can create a more engaging and memorable experience, particularly for group outings, celebrations, or special occasions where personalization is desired.

In another preferred embodiment, off the course, the versatility of the personal media display feature expands the golf cart 100's utility in different settings beyond traditional golfing applications. At resorts or vacation communities where golf carts are used for general transportation, residents or guests can personalize their rides with family photos, vacation memories, or themed imagery. During special events like weddings, festivals, or community gatherings, the roof display 102 could showcase themed images or videos related to the occasion, adding to the celebratory atmosphere. The ability to display photos of favorite bands, athletes, or sports teams further personalizes the golf cart 100, potentially making it a mobile expression of the user's interests and passions. This feature could be particularly appealing in settings such as music festivals, sporting events, or tailgate gatherings where personal expression is valued. In some instances, the personal media display feature may integrate seamlessly with other functionalities of the roof display 102, allowing users to alternate between personal photos and informational displays like course maps or weather updates based on their current needs.

In some preferred embodiments, the roof display 102 may display celestial events and astronomical imagery for ambiance and entertainment purposes. For instance, the display may be configured to display a randomized star pattern across the roof, creating an immersive nighttime atmosphere for occupants. The light emitters 103 may feature a twinkling effect that softly pulses, mimicking the gentle flicker of stars in the night sky and enhancing the visual experience. In another preferred embodiment, the roof display 102 may simulate a meteor shower with streaking lights across the roof, providing dynamic visual entertainment during evening use. The meteor shower effect may be created by coordinating specific sequences of light emitters 103 to illuminate briefly in rapid succession, creating the illusion of streaking lights moving across the roof in various directions. The control module may vary the frequency, direction, and intensity of these simulated meteors to create a more realistic and engaging display that can be customized to user preferences.

In a preferred embodiment, these celestial effects can be further enhanced by incorporating color variations to increase visual interest and realism. For instance, the star pattern could include subtle hues to represent different star types, such as blue-white for hot stars or reddish tones for cooler stars, while the meteor shower might feature color gradients to simulate atmospheric interactions as meteors enter the atmosphere. The control module could also be programmed to slowly rotate the star pattern over time, mimicking the Earth's rotation and providing a changing view of the night sky throughout the evening. Additionally, these effects can be synchronized with the golf cart 100's movement or external factors to create responsive displays. For example, the intensity of the star pattern could adjust based on the ambient light levels detected by sensors, becoming brighter in darker environments and dimming in areas with more light pollution. In some instances, the meteor shower effect could be triggered by specific events, such as the completion of a hole in golf or reaching a destination, adding an element of celebration or reward to the display.

In some preferred embodiments, the roof display 102 may project a real-time view of the night sky, complete with labeled constellations for educational and entertainment purposes. The control module may use GPS data, compass data, and astronomical databases to accurately represent the current celestial view based on the golf cart 100's location, time, and orientation. This feature may operate by first determining the golf cart 100's precise location using GPS coordinates, then referencing this location against its astronomical database, which contains information on the positions of stars, planets, and other celestial bodies. The compass data can ensure that the displayed sky view is correctly oriented relative to the golf cart 100's heading, providing an accurate representation of what would be visible overhead. The resulting display on the roof can show a wide array of celestial objects and phenomena, with stars represented by light emitters of varying brightness and color to reflect their actual appearance. In some instances, constellations can be outlined and labeled, providing easy identification for users interested in learning about astronomy.

In another preferred embodiment, the system may also highlight planets, satellites, and the International Space Station as they move across the sky, providing real-time tracking of these objects. To enhance the educational value, the display could include additional information such as the names of prominent stars, their distances from Earth, or interesting facts about various celestial objects that users can access through the interface. The system could also simulate the movement of celestial bodies over time, allowing users to observe how the night sky changes throughout the night or across different seasons. In educational settings, such as astronomy outings, nature tours, or science camps where golf carts are used for transportation, the roof display 102 can become a teaching tool for instructors. Instructors could use the display to point out celestial objects and explain astronomical concepts in real-time, making abstract ideas more tangible and accessible to learners of various ages. In some instances, the astronomical display may include augmented reality features that overlay information about celestial objects when users point to specific areas of the display.

In some preferred embodiments, the roof display 102 may be configured to respond to various external stimuli, creating dynamic and interactive lighting experiences for occupants. One such stimulus is music, where the light emitters 103 can synchronize their illumination patterns with the rhythm, tempo, or other characteristics of the audio being played. This music-responsive feature can be implemented through several methods, including microphone input, connected device integration, and onboard sound system integration. For instance, the system may incorporate a microphone to capture ambient sound, including music played within the golf cart 100 or in its vicinity, with the control module analyzing this audio input in real-time. The control module can extract features such as beat, frequency spectrum, or volume levels to drive the lighting patterns, creating visual representations of the music. In some instances, users may connect their smartphones, tablets, or other audio devices to the golf cart 100's system via Bluetooth or other wireless protocols, allowing for more precise analysis of the music data and potentially enabling more sophisticated synchronization between the audio and visual elements.

In a preferred embodiment, if the golf cart 100 is equipped with its own audio system, the roof display 102 can be directly integrated with it, allowing for seamless coordination between the music playback and lighting effects without external devices. The control module may process the audio input using various algorithms to create visually appealing and rhythmically accurate lighting patterns, including beat detection, frequency analysis, and volume responsiveness. For instance, beat detection may illuminate specific light emitters or change colors in sync with the music's beat, creating a pulsing effect that matches the tempo. Frequency analysis may map different frequency ranges to various colors or sections of the roof display 102, creating a dynamic spectrum visualization where bass frequencies might trigger one color while treble frequencies trigger another. Volume responsiveness may adjust the overall brightness or intensity of the lighting based on the music's volume, creating crescendo effects during loud passages. In some instances, users may be able to customize the relationship between audio characteristics and visual effects through the user interface, tailoring the music-responsive display to their preferences.

In addition to music responsiveness, the roof display 102 can also react to the golf cart 100's movement, creating motion-responsive visual effects. This feature may utilize data from accelerometers or gyroscopes to detect changes in speed, direction, or terrain, with the lighting patterns adjusted accordingly. Types of movement that may be used by the system to change lighting patterns include acceleration data, turn indicators, and terrain-based effects. For instance, the system may intensify the brightness or shift the pattern towards the rear of the display when the cart accelerates, creating a sense of motion. Alternatively, the system may animate light patterns to indicate left or right turns, potentially serving as supplementary turn signals visible to occupants. In some preferred embodiments, the display may change colors or patterns based on whether the cart is on flat ground, inclines, or rough terrain, providing visual feedback about the driving conditions. These motion-responsive features can enhance the visual appeal while also serving practical purposes, such as improving visibility or communication with other vehicles or pedestrians in the vicinity.

In another preferred embodiment, the roof display 102 can be designed to mimic the golf cart 100's surroundings, particularly the sky, to create a virtual sunroof effect for occupants. This feature may utilize one or more cameras mounted on the exterior of the golf cart 100 to capture real-time images of the sky above the vehicle. The control module may then process these images and translate them into appropriate lighting patterns on the roof display 102, reproducing the colors and patterns of the sky overhead. This can create the illusion of transparency, as if the roof were made of glass, offering occupants a view of the sky without compromising the structural integrity or weather protection of the roof assembly 101. In some instances, the virtual sunroof effect may include enhancements such as increased color saturation or contrast adjustment to improve the visual experience. The present disclosure contemplates that the virtual sunroof feature may be combined with other display modes, such as overlaying weather information or constellation labels on the sky imagery.

The above features represent examples of functionality that can be provided by the roof display 102, and the present disclosure contemplates additional display modes and content types beyond those specifically described. In addition to the roof display 102, the golf cart 100 may also incorporate a front display 105 integrated into the front cowl 104, offering further opportunities for visual enhancement and information presentation to external observers. As illustrated in FIGS. 1A and 1B, the front cowl 104 may form part of the golf cart 100's front section, typically housing components such as headlights and providing aerodynamic shaping for the vehicle. In some preferred embodiments, the front cowl 104 may be designed to accommodate the front display 105, which may be positioned for visibility to external observers approaching from the front of the vehicle. Alternatively, the front display 105 may be configured to fit within existing front cowl designs, allowing for retrofit installation on golf carts with standard front cowl configurations. In some instances, the front display 105 may be integrated with or attached to the front cowl 104, or may be attached to another portion of the golf cart 100 depending on the specific vehicle design and installation preferences.

In a preferred embodiment, the front display 105 may be designed to complement the aesthetic of the front cowl 104 while offering functional display capabilities for various applications. As illustrated in FIGS. 1A and 1B, the front display 105 may provide a visible surface for presenting information or decorative patterns to observers outside the vehicle, enhancing the golf cart 100's visual presence. In some preferred embodiments, the front display 105 may comprise a plurality of light emitters, similar to those used in the roof display 102, providing consistent display technology across the vehicle. These light emitters may be LED bulbs, fiber optic ends, or part of a screen such as an LCD, plasma, or OLED screen, depending on the desired visual characteristics and environmental requirements. The front display 105 may serve multiple purposes, enhancing both the aesthetic appeal and functionality of the golf cart 100 in various operational contexts. In some instances, the front display 105 may be used to showcase decorative images or patterns, potentially coordinating with or complementing the visual effects displayed on the roof display 102 to create a unified visual theme.

In some preferred embodiments, the front display 105 may serve as a versatile platform for presenting a wide range of useful information beyond decorative patterns. In addition to showing the golf cart manufacturer's logo or branding, the front display 105 can be utilized for more dynamic and context-specific information based on the operational environment. For instance, the front display 105 could be programmed to show the current hole number and par information when used on a golf course, helping players and course staff quickly identify the cart's location on the course. In tournament settings, it could display the names or team affiliations of the players using the cart, facilitating easier identification for spectators, officials, and media personnel. At resorts or large venues, the front display 105 could indicate specific routes or destinations, such as directional information for guests navigating complex property layouts. In some instances, this feature could be particularly useful during events or in resort environments where clear directional information can enhance guest experience and reduce confusion.

In another preferred embodiment, in maintenance or staff use scenarios, the front display 105 could show status information such as maintenance notifications, service status, charge level percentage, or charging status to communicate the cart's current state to potential users or other staff members. This can help streamline operations and reduce confusion about vehicle availability in fleet management situations. For rental or shared-use environments, the front display 105 could show rental information, such as the duration of use, return time, or reservation status, helping both users and staff manage cart usage more effectively. In corporate or event settings, the display could be used to show sponsor logos, event-specific branding, or promotional content, adding value for organizers and sponsors while enhancing the event atmosphere. In some instances, the front display 105 may be configured to automatically update its content based on location, time of day, or operational mode, reducing the need for manual content management. The present disclosure contemplates that the front display 105 may display different content types simultaneously in different zones, such as showing branding in one area while displaying status information in another.

In some preferred embodiments, the front display 105 may be designed to operate in conjunction with the roof display 102, potentially sharing control systems and power sources for simplified installation and operation. This integration may allow for coordinated visual effects or information display across both the roof and front of the golf cart 100, enhancing the overall visual impact and functionality of the display system. The positioning of the front display 105 on the front cowl 104 may provide high visibility to external observers, potentially serving as an effective means of communication, identification, or advertisement. In some preferred embodiments, the front display 105 may be designed to be visible in various lighting conditions, ensuring that displayed information or patterns remain clear and legible whether in bright sunlight or low-light environments. The front display 105 may incorporate brightness sensors that automatically adjust the display intensity based on ambient light levels, optimizing visibility while conserving power. In some instances, the front display 105 may include anti-glare coatings or treatments to improve readability in direct sunlight conditions commonly encountered during outdoor use.

Although display features may be described herein with respect to one display, such as the roof display 102 or the front display 105, they are not limited as such and may be applied to either or both displays as appropriate. Features described with respect to the roof display 102 may also be displayed on the front display 105 and vice versa, providing flexibility in how content is presented to occupants and external observers. The roof display 102 and front display 105 may be configured to display the same or different types of information depending on the intended use and user preferences. In addition to the roof display 102 and front display 105, the golf cart 100 may incorporate displays in various other locations to enhance functionality and user experience. These additional displays may include any of the display items described herein and may be positioned based on visibility requirements and intended audience. In some instances, the various displays may mirror, complement, or contrast with the other displays to create cohesive or differentiated visual presentations across the vehicle.

In some preferred embodiments, side displays may be integrated into the body panels of the golf cart 100, providing visibility to observers approaching from the sides of the vehicle. These side displays may show identification names or numbers, decorative patterns, advertisements, or directional information for events or large venues where side visibility is beneficial. The golf cart 100's rear section may also accommodate a display, potentially useful for communicating with following vehicles or pedestrians behind the cart. This rear display may show brake light signals, turn indicators, or messages such as slow vehicle warnings or caution notifications to enhance safety during operation. In another preferred embodiment, displays may be incorporated into the dashboard area or may be a Heads-Up Display (HUD) integrated into a windshield, providing a customizable interface for the driver and front passenger. These displays may show vehicle information, navigation data, speed, battery status, or entertainment options depending on user preferences and operational needs.

In some preferred embodiments, the steering wheel may feature a small integrated display for quick access to information without taking hands off the wheel, enhancing safety and convenience during operation. The golf cart 100's seating area may include displays on the back of the front seats, visible to rear passengers, which may offer entertainment options, course information, or interactive features for passengers seated in the rear. In some instances, the golf bag holder area may incorporate narrow displays to show club-specific information, such as suggested club selection based on current hole and player position, or provide storage slot labels for organizing clubs. Alternatively, removable or interchangeable display modules may be designed to attach to various points on the golf cart 100, allowing for flexible customization based on specific events or user preferences. These modular displays may be easily swapped or repositioned as needed, providing adaptability for different use cases without permanent modifications to the vehicle. The present disclosure contemplates that the various display locations described herein may be used individually or in combination to create comprehensive visual systems tailored to specific applications and user requirements.

As illustrated in FIG. 2, the golf cart display system may include a control module that serves as the central processing unit for managing various components and functionalities throughout the system. In a preferred embodiment, the control module may be connected to multiple components including a roof display, a front display, a power source, and a user interface, enabling coordinated operation of these elements. The control module may be comprised of one or more individual units that can operate independently or in concert to manage display operations. In some preferred embodiments, the control module may be configured to exist as separate components, may be integrated into an existing component of the golf cart such as the dashboard electronics, or may be integrated into one or more of the displays themselves. The present disclosure contemplates that the control module may draw power from the power source to operate the system components efficiently. The power source may be the golf cart's existing power system, such as the main battery pack, or may alternatively be a separate power source such as an auxiliary battery or solar panel array mounted on the roof assembly.

In another preferred embodiment, the control module may manage communication between connected components, enabling various display functionalities including decorative patterns, informational displays, and interactive features for occupants and external observers. The control module may utilize wired connections such as CAN bus or Ethernet, or wireless connections such as Bluetooth, Wi-Fi, or Zigbee to communicate with the user interface, front display, or roof display. In some instances, the control module may be configured to process input from the user interface and coordinate visual outputs on both the roof and front displays simultaneously or independently. The display system may include a user interface that allows users to interact with and customize the displays according to their preferences and operational needs. This interface may be accessible via a built-in control panel integrated into the golf cart's dashboard area or through a mobile application on a user's smartphone or tablet that connects wirelessly to the control module. The user interface can optionally provide preset display modes for quick selection as well as advanced customization options for users who desire more granular control over display parameters.

In some preferred embodiments, the control module may connect to a local network or the Internet, either directly through an onboard cellular modem or via the user interface acting as a bridge to network connectivity. For instance, the control module may establish a Bluetooth connection with a user's mobile device to receive information from the internet, enabling access to cloud-based services and real-time data feeds. The control module may then request and retrieve data via the network connection, such as weather forecasts, course layout updates, or promotional content to be displayed on the roof display or front display. In a preferred embodiment, the control module may include or be connected to devices capable of receiving location information, weather information, audio information, or visual information from the surrounding environment. As illustrated in FIG. 2, the control module may incorporate or be linked to one or more sensors such as GPS sensors, compasses, barometers, anemometers, accelerometers, gyroscopes, microphones, radar, ultrasonic sensors, LIDAR, or cameras. The present disclosure contemplates that these sensors may be mounted at various locations on the golf cart 100 to optimize data collection and provide comprehensive environmental awareness for the display system.

In some preferred embodiments, these sensors may provide data that can be used to adjust the displays based on environmental conditions or user activities, creating context-aware visual experiences. GPS sensors may enable location-based display features, such as showing course maps with the current position highlighted or providing distance information to specific points on a golf course such as the green, hazards, or the clubhouse. Compass sensors may allow for orientation-specific displays, potentially useful for indicating wind direction relative to the golf cart's heading or aligning course maps so that the top of the display corresponds to the direction the cart is facing. Barometers may detect changes in atmospheric pressure, which can be used to predict short-term weather changes such as approaching storms and update weather-related displays accordingly to alert occupants. Anemometers may measure wind speed and direction, providing real-time wind data that can be visualized on the displays through animated arrows or numerical readouts to assist golfers in shot selection and club choice. In some instances, the combination of barometric and anemometric data may enable the system to provide comprehensive weather assessments that enhance the golfing experience.

In another preferred embodiment, accelerometers and gyroscopes may detect the golf cart's movement and orientation, potentially enabling motion-responsive display effects such as shifting color patterns during turns or providing data for terrain-aware features that indicate uphill or downhill travel. Microphones may capture ambient sound or user voice commands, allowing for audio-responsive display modes where lighting patterns pulse to music or voice-controlled interface interactions that enable hands-free operation of display settings. Radar, ultrasonic sensors, and LIDAR may provide detailed information about the surrounding environment, potentially useful for obstacle detection that triggers warning displays or creating augmented reality display overlays that highlight nearby features. Cameras may capture visual information that can be used for various purposes, such as creating a virtual sunroof effect on the roof display by reproducing the sky above or enabling gesture-based controls where users can change display modes through hand movements. In some preferred embodiments, the system may utilize multiple sensor types in combination to provide more accurate and comprehensive data for display operations. For instance, GPS data can be supplemented with inertial measurements from accelerometers and gyroscopes to improve location accuracy when GPS signals are weak or unavailable, such as when the golf cart passes under dense tree canopy or near tall structures.

The present disclosure contemplates that the integration of various sensor types may allow for more sophisticated and context-aware display functionalities, enhancing the overall user experience of the golf cart display system across diverse operational environments. In a preferred embodiment, sensor data may be processed by the control module using algorithms that filter noise, correlate multiple data streams, and generate actionable display commands in real-time. The control module may be configured to prioritize certain sensor inputs based on the current display mode, such as emphasizing GPS and compass data when displaying course maps or prioritizing microphone input when in music-responsive lighting mode. In some instances, the system may store historical sensor data to identify patterns and optimize display responses over time, such as learning typical routes through a resort property and pre-loading relevant directional information. Alternatively, the control module may transmit anonymized sensor data to cloud services for aggregation and analysis, potentially enabling features such as crowd-sourced course condition reports or traffic pattern visualization for fleet management applications. The flexibility of the sensor integration architecture may allow for future expansion as new sensor technologies become available, enabling the golf cart display system to incorporate additional data sources without substantial hardware modifications.

In a preferred embodiment, the present disclosure describes how the components illustrated in FIGS. 1A and 1B and the display system illustrated in FIG. 2 may be incorporated into a golf cart 100 to create an integrated customizable display system. As illustrated in FIG. 1A, the golf cart 100 may include a roof assembly 101 that supports a roof display 102 containing a plurality of light emitters 103, while a front cowl 104 accommodates a front display 105 positioned for visibility to external observers. The control module illustrated in FIG. 2 may be configured to coordinate the operation of these display components by processing sensor inputs and generating appropriate visual outputs on the roof display 102 and front display 105. In some instances, the integration of these components may involve mounting the roof assembly 101 to the structural supports of the golf cart 100 while routing electrical connections from the control module to the light emitters 103 and front display 105. The control module can optionally be housed within the dashboard area of the golf cart 100 or alternatively positioned within the roof assembly 101 itself to minimize wiring distances. This integrated approach may allow for coordinated visual effects across multiple display surfaces while maintaining the structural integrity and aesthetic appeal of the golf cart 100.

In some preferred embodiments, the roof display 102 may be installed within the roof assembly 101 by positioning the light emitters 103 in a downward-facing orientation so that visual content is visible to occupants seated below. As illustrated in FIG. 1B, the roof assembly 101 may include a decorative polymer surround that frames the roof display 102 and provides a finished appearance when viewed from inside the golf cart 100. The light emitters 103 can be secured to a substrate or backing panel within the roof assembly 101, with electrical connections routed through channels or conduits to the control module. In some instances, a cover panel may be positioned over the light emitters 103 to provide protection from environmental exposure while optionally incorporating optical elements such as diffraction gratings or frosted surfaces to modify the emitted light. The cover panel may be configured to be removable or interchangeable, allowing users to customize the optical characteristics of the roof display 102 based on their preferences. Alternatively, the cover panel may be permanently affixed to the roof assembly 101 using adhesives, fasteners, or snap-fit connections depending on the desired level of serviceability.

In another preferred embodiment, the front display 105 may be integrated into the front cowl 104 by mounting the display components within a recessed area or behind a transparent or translucent panel that forms part of the front cowl 104 structure. As illustrated in FIGS. 1A and 1B, the front display 105 may be positioned to provide visibility to external observers approaching from the front of the golf cart 100, enabling the presentation of branding, identification, or informational content. The front display 105 can include light emitters similar to those used in the roof display 102, such as LEDs, fiber optic ends, or pixels of a screen-type display. In some instances, the front display 105 may be configured to operate independently of the roof display 102, displaying different content types based on the operational context or user preferences. The control module may manage the front display 105 through wired or wireless connections, coordinating its visual output with the roof display 102 when synchronized effects are desired. Alternatively, the front display 105 may receive power and control signals through a dedicated connection separate from the roof display 102 to provide redundancy in the event of a component failure.

The present disclosure contemplates that the control module illustrated in FIG. 2 may serve as the central processing unit for managing the various sensors and display components incorporated into the golf cart 100. In a preferred embodiment, the control module may receive input from sensors such as GPS sensors, compasses, barometers, anemometers, accelerometers, gyroscopes, microphones, and cameras, processing this data to generate context-aware display content. The control module can be configured to communicate with the roof display 102 and front display 105 using wired connections such as CAN bus or Ethernet, or wireless connections such as Bluetooth or Wi-Fi depending on the installation configuration. In some instances, the control module may include memory storage for retaining user preferences, display configurations, and sensor data that can be used to optimize display responses over time. The user interface may connect to the control module through a built-in control panel integrated into the golf cart 100's dashboard or through a mobile application on a user's smartphone or tablet. As illustrated in FIG. 2, the interconnection of these components may enable sophisticated display functionalities that respond to environmental conditions, user inputs, and external stimuli such as music or vehicle motion.

In some preferred embodiments, the power source for the display system may be derived from the golf cart 100's existing electrical system, such as the main battery pack that powers the vehicle's propulsion system. The control module may include voltage regulation circuitry to convert the battery voltage to appropriate levels for the light emitters 103, front display 105, and sensor components. Alternatively, a separate auxiliary battery or solar panel array mounted on the roof assembly 101 may provide dedicated power for the display system, allowing the displays to operate without drawing from the main propulsion battery. In some instances, the power source may be configured to include battery management features that monitor charge levels and adjust display brightness or functionality to conserve power when battery levels are low. The present disclosure contemplates that the display system may optionally include power-saving modes that reduce energy consumption during periods of inactivity or when the golf cart 100 is parked. As illustrated in FIG. 3, the golf cart 100 may operate in various outdoor environments where power management can enhance the usability and range of the vehicle while maintaining display functionality.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

What is claimed is:

1. A golf cart with a customizable display system, comprising:
a body structure configured to accommodate passengers;
a roof assembly supported above the body structure;
a roof display integrated into the roof assembly, the roof display comprising a plurality of light emitters arranged in a pattern and configured to emit light downward toward occupants of the golf cart;
a front cowl forming a front section of the golf cart;
a front display positioned on the front cowl and configured to present visual information to external observers; and
a control module operatively connected to the roof display and the front display, the control module configured to control visual output of the roof display and the front display.

2. The golf cart of claim 1, wherein the plurality of light emitters comprises LEDs.

3. The golf cart of claim 2, wherein the roof display further comprises a cover panel positioned over the plurality of light emitters, the cover panel having a finish selected from the group consisting of clear, translucent, smoked, and mirrored.

4. The golf cart of claim 3, wherein the cover panel comprises an optical element configured to modify light emitted by the plurality of light emitters, the optical element selected from the group consisting of a frosted surface, a diffraction grating, and a prism.

5. The golf cart of claim 1, wherein the plurality of light emitters comprises ends of fiber optic strands fed by at least one light source.

6. The golf cart of claim 1, wherein the plurality of light emitters comprises pixels of a display screen selected from the group consisting of an LCD, an OLED display, a plasma display, and a microLED display.

7. The golf cart of claim 1, further comprising a user interface operatively connected to the control module, the user interface configured to allow a user to adjust parameters of the visual output including brightness, color, and dynamic effects.

8. The golf cart of claim 7, wherein the user interface comprises a mobile application configured to communicate wirelessly with the control module.

9. The golf cart of claim 1, wherein the control module is configured to coordinate the visual output of the roof display and the front display to display synchronized visual effects.

10. A golf cart display system, comprising:
a roof display configured to be integrated into a roof assembly of a golf cart, the roof display comprising a plurality of light emitters arranged to emit light toward occupants of the golf cart;
a cover panel positioned over the plurality of light emitters;
a front display configured to be positioned on a front cowl of the golf cart and configured to present visual content to external observers;
a control module operatively connected to the roof display and the front display; and
a user interface configured to allow a user to adjust parameters of the roof display and the front display.

11. The golf cart display system of claim 10, wherein the plurality of light emitters comprises LEDs arranged in a customizable pattern across a surface of the roof display.

12. The golf cart display system of claim 11, wherein the cover panel comprises an optical element selected from the group consisting of a frosted surface configured to diffuse light, a diffraction grating configured to create patterns, and a prism configured to split light into component colors.

13. The golf cart display system of claim 10, further comprising at least one sensor operatively connected to the control module, the at least one sensor selected from the group consisting of a GPS sensor, a compass, a barometer, an anemometer, an accelerometer, a gyroscope, a microphone, and a camera.

14. The golf cart display system of claim 13, wherein the control module is configured to adjust the visual output of the roof display based on data received from the at least one sensor.

15. The golf cart display system of claim 14, wherein the control module is configured to display an interactive map of a golf course on the roof display based on location data received from the GPS sensor, the interactive map including a real-time indication of a position of the golf cart relative to course features.

16. The golf cart display system of claim 10, wherein the control module is configured to synchronize lighting effects of the roof display with audio input received from a microphone, the lighting effects pulsing in response to rhythm characteristics of the audio input.

17. A method for enhancing a golf cart experience, comprising:
displaying, via a roof display integrated into a roof assembly of a golf cart, customizable lighting patterns visible to occupants of the golf cart, wherein the roof display comprises a plurality of light emitters;
presenting, via a front display positioned on a front cowl of the golf cart, visual information to external observers; and
controlling, via a control module operatively connected to the roof display and the front display, the customizable lighting patterns and the visual information based on at least one of user input, sensor data, or external stimuli.

18. The method of claim 17, wherein displaying the customizable lighting patterns comprises displaying a celestial effect selected from the group consisting of a randomized star pattern, a simulated meteor shower with streaking lights, and a twinkling effect mimicking stars in a night sky.

19. The method of claim 18, further comprising receiving audio input via a microphone operatively connected to the control module, and synchronizing the customizable lighting patterns with rhythm characteristics of the audio input.

20. The method of claim 17, further comprising:
receiving location data from a GPS sensor operatively connected to the control module;
displaying an interactive map of a golf course on the roof display based on the location data; and
updating the interactive map in real-time to indicate a current position of the golf cart relative to course features including at least one of a green, a hazard, or a tee box.
